(19) United States
(12) Patent Application Publication
(10) Pub. No.: US 2017/0306194 A1
(43) Pub. Date: Oct. 26, 2017

(54) ADHESIVE FILM, OPTICAL MEMBER COMPRISING THE SAME AND OPTICAL DISPLAY COMPRISING THE SAME

(71) Applicants: SAMSUNG SDI CO., LTD., Yongin-si (KR); SAMSUNG ELECTRONICS CO., LTD., Suwon-si (KR)

(72) Inventors: Byeong Do KWAK, Suwon-si (KR); Ji Ho KIM, Suwon-si (KR); Ji Won KANG, Suwon-si (KR); Il Jin KIM, Suwon-si (KR); Sung Hyun MUN, Suwon-si (KR); Seon Hee SHIN, Suwon-si (KR); Hyung Rang MOON, Suwon-si (KR); Gwang Hwan LEE, Suwon-si (KR); Jin Young LEE, Suwon-si (KR); Ik Hwan CHO, Suwon-si (KR); Jae Hyun HAN, Suwon-si (KR); In Chul HWANG, Suwon-si (KR)

(21) Appl. No.: 15/495,838

(22) Filed: Apr. 24, 2017

(30) Foreign Application Priority Data
Apr. 25, 2016 (KR) 10-2016-0050425
Dec. 14, 2016 (KR) 10-2016-0170839

(51) Int. Cl. C09J 133/08; C09J 7/02; G02B 1/04; C08F 220/16; C08K 9/10

(52) U.S. Cl. CPC C09J 133/08; C08F 220/16; C08K 9/10; G02B 1/04; C09J 7/0285; C08K 2201/003; C08F 2800/20; C09J 2205/102; C09J 2205/114; C09J 2433/00; C09J 2467/006; C09J 2203/326

(57) ABSTRACT

An adhesive film, an optical member including the same, and an optical display including the same are provided. An adhesive film includes a (meth)acrylic copolymer including a hydroxyl group and formed of a monomer mixture including a hydroxyl group-containing (meth)acrylate and an alkyl group-containing (meth)acrylate. The adhesive film has a glass transition temperature of about −35° C. or less and allows about 50,000 cycles or more of bending before delamination between the adhesive film and a PET film, cracking, or bubble generation occurs in a specimen as described herein.

### CROSS-REFERENCE TO RELATED APPLICATION

This application claims priority to and the benefit of Korean Patent Application No. 10-2016-0050425, filed on Apr. 25, 2016 and Korean Patent Application No, 10-2016-0170839, filed on Dec. 14, 2016 in the Korean Intellectual Property Office, the entire disclosure of each of which is incorporated herein by reference.

### BACKGROUND

### 1. Field

Aspects of embodiments of the present invention relate to an adhesive film, an optical member including the same, and an optical display including the same.

### 2. Description of the Related Art

An optical display includes display devices including a window film, a conductive film, an organic light emitting diode, and the like. In the optical display, various display devices are attached to each other via optically clear adhesives (OCAs). Recently, a flexible optical display has been developed.

In a flexible optical display, an adhesive film is required to have good foldability not only at room temperature but also under severe conditions, for example, at low temperature (for example, −20° C.) or high temperature/humidity (for example, 60° C. and 93% relative humidity (RH)). Particularly, since an outer temperature of the adhesive film decreases at low temperature, the adhesive film often fails to exhibit foldability at low temperature even when the adhesive film exhibits good foldability at room temperature. On the other hand, in the optical display, the adhesive film is attached to an optical member or an optical film instead of being separately placed. Thus, although the adhesive film can exhibit good foldability when used alone, the foldability of the adhesive film can be deteriorated due to influence of a plurality of optical members and optical films having different physical properties when mounted together with the optical members and optical films in the optical display. Moreover, since the adhesive film can be used not only at room temperature, but also at low temperature or high temperature, a large modulus difference of the adhesive film between high temperature and low temperature can cause deterioration in reliability thereof.

The background technique of the present invention is disclosed in Korean Patent Publication No. 2007-0055363 A.

### SUMMARY

According to an aspect of one or more embodiments of the present invention, an adhesive film includes a (meth)acrylic copolymer including a hydroxyl group and formed of a monomer mixture including a hydroxyl group-containing (meth)acrylate and an alkyl group-containing (meth)acrylate, the adhesive film has a glass transition temperature of about −35° C. or less, the adhesive film allows about 50,000 cycles or more of bending before delamination between the adhesive film and a PET film, cracking, or bubble generation occurs in a specimen having a length of 100 cm and a width of 160 cm and prepared by sequentially stacking a first PET film having a thickness of 100 μm, the adhesive film having a thickness of 50 μm, a second PET film having a thickness of 50 μm, the adhesive film having a thickness of 50 μm, and a third PET film having a thickness of 125 μm to have a five-layer structure, as measured by securing the specimen to a folding test instrument by bending the specimen towards the third PET film such that the width of the specimen is halved, and repeating a cycle of bending the specimen under conditions of at least one of i) −20° C., and ii) 60° C. and 93% relative humidity, at a bending rate of 30 cycles per minute, such that the specimen is repeatedly bent and unbent at 0° and 180° in a direction of the width of the specimen, and a bent portion of the specimen has a radius of curvature of 3 mm, and one cycle refers to an operation of bending the specimen in half once and unfolding the specimen back to an original state.

According to another aspect of one or more embodiments of the present invention, an optical member includes an optical film and the above-described adhesive film formed on at least one surface of the optical film.

According to another aspect of one or more embodiments of the present invention, an optical display includes the above-described adhesive film.

### BRIEF DESCRIPTION OF DRAWINGS

FIG. 1 is a sectional view of an optical display according to an embodiment of the present invention.

FIGS. 2A and 2B are conceptual diagrams of a specimen for measuring peel strength.

FIG. 3 is a sectional view of a specimen for foldability evaluation.

FIGS. 4A and 4B are, respectively, a sectional view and a plan view of a specimen for measuring restoration force.

FIG. 5 is a graph for calculation of restoration force.

### DETAILED DESCRIPTION

Herein, some embodiments of the present invention will be described in further detail with reference to the accompanying drawings to allow those skilled in the art to practice the present invention. It is to be understood that the present invention may be embodied in different ways and is not limited to the following embodiments. In the drawings, portions irrelevant to the description will be omitted for clarity. Like components will be denoted by like reference numerals throughout the specification.

As used herein, spatially relative terms such as “upper” and “lower” are defined with reference to the accompanying drawings. Thus, it is to be understood that “upper” can be used interchangeably with “lower.” It is to be understood that, when a layer is referred to as being “on” another layer, it can be directly formed on the other layer, or one or more intervening layers may also be present. Thus, it is to be understood that, when a layer is referred to as being “directly on” another layer, no intervening layer is interposed therebetween.

As used herein, the term “(meth)acryl” refers to acryl and/or methacryl.

Herein, the term “copolymer” may include an oligomer, a polymer, or a resin.

Herein, the “average particle diameter” of organic nanoparticles refers to a particle diameter thereof, as measured in a water-based or organic solvent using a Zetasizer nano-ZS (Malvern Co., Ltd.) and represented by a Z-average value, and identified by scanning electron microscope (SEM)/transmission electron microscope (TEM).

Herein, “modulus” means storage modulus (G′).

Herein, “foldability evaluation” means an operation of repeating a cycle of bending (folding) a specimen under conditions of i) −20° C, or ii) 60° C. and 93% RH, at a bending rate of 30 cycles per minute, such that the specimen is repeatedly bent and unbent at 0° and 180° in a direction of width of the specimen, and a bent portion of the specimen has a radius of curvature of 3 mm, and one cycle refers to an operation of bending the specimen in half once and unfolding the specimen back to an original state. The specimen (length×width: 100 cm×160 cm) is prepared by sequentially stacking a first PET film (thickness: 100 μm), an adhesive film (thickness: 50 μm), a second PET film (thickness; 50 μm), an adhesive film (thickness: 50 μm) and a third PET film (thickness: 125 μm) to have a five-layer structure. The specimen is secured to a folding test instrument (CFT series, COVOTEC Co., Ltd.) by bending the specimen towards the third PET film such that the width of the specimen is halved. The specimen is a simulation model of a display in which a display part, an adhesive film, an optical film (e.g., a polarizing plate or touchscreen panel), an adhesive film, and a window film are sequentially stacked one above another.

Herein, “good foldability” means a case in which a specimen allows about 50,000 cycles or more of bending before delamination between an adhesive film and a PET film, cracking, and/or bubble generation occur in the specimen upon the foldability evaluation at −20° C. or at 60° C. and 93% RH. Bubble generation can be evaluated based on a bubble generation area ratio, without being limited thereto. The bubble generation area ratio refers to a value (%) measured on the specimen by analyzing an image. The image is obtained by photographing a portion of the adhesive film suffering from bubble generation, using an optical microscope (EX-51, Olympus Co., Ltd., magnification: 30×). The bubble generation area ratio is calculated as a ratio (%) of the total area occupied by bubbles to the area of the specimen, by analyzing the image with Mac-View software (Mountech Co., Ltd.). A bubble generation area ratio of 0% indicates no bubble generation.

Herein, “restoration force” can be calculated by Equation 1:

Restoration force−(1−(X₁)/(X₂))×100, <Equation >

where X₁ and X₂ are values obtained under the following procedure, wherein both ends of a polyethylene terephthalate (PET) film are defined as a first end and a second end, respectively. A specimen for calculation of restoration force is prepared by attaching a first PET film and a second PET film to each other via an adhesive film having a size of 20 mm×20 mm, such that two ends of the first PET film and the second PET film are attached to each other in order of a first end of the first PET film/adhesive film/a second end of the second PET film. Thereafter, one jig is secured to a second end of the first PET film and another jig is secured to a first end of the second PET film. One of the jigs is secured under a load of 10 MPa. The other jig is pulled at 25° C. and at about 300 mm/min until the adhesive film has a length X₂ (unit: μm) of 1,000% of an initial thickness X₀(unit: μm) of the adhesive film, that is, 10 times the initial thickness X₀ of the adhesive film, and is maintained for about 10 seconds, followed by restoring the other jig at the same speed (at about 300 mm/min) as the pulling speed, to obtain a stretched length X₁ (unit: μm) of the adhesive film upon application of 0 KPa to the adhesive film in a graph, wherein the X-axis of the graph is the stretched length of the adhesive film, and the Y-axis of the graph is force applied to the adhesive film.

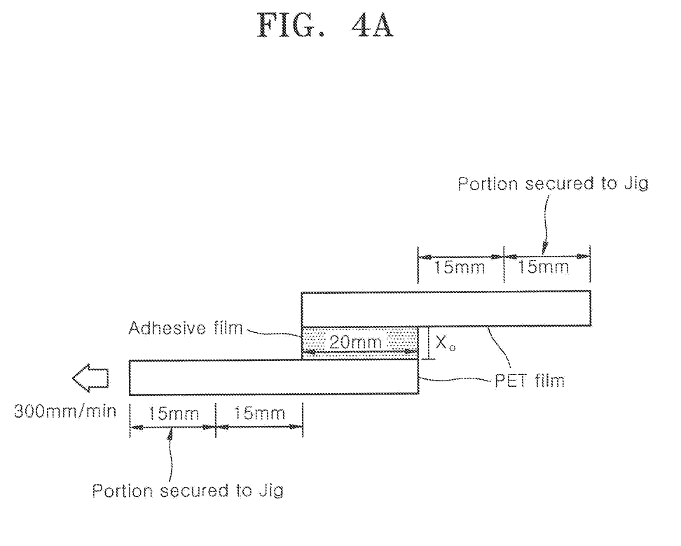

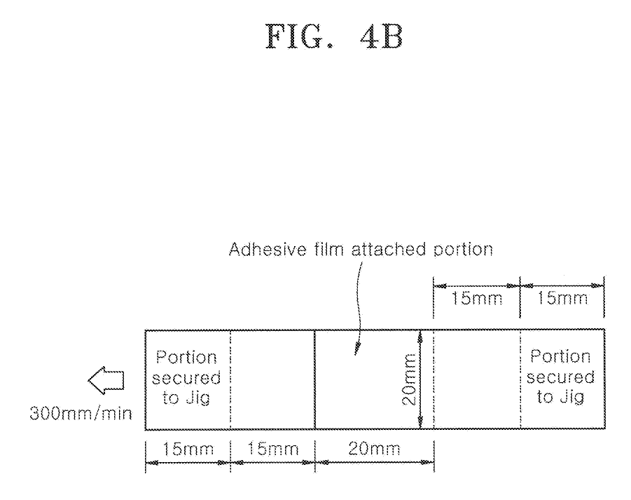

FIGS. 4A and 4B are, respectively, a sectional view and a plan view of one example of a specimen for calculation of restoration force. Here, assuming that both ends of a polyethylene terephthalate (PET) film having a size of 50 mm×20 mm×75 μm (length×width×thickness) are defined as a first end and a second end, respectively, two PET films are attached to each other via an adhesive film having a size of 20 mm×20 mm, such that two ends of the PET films are attached to each other by the adhesive film in order of first end of first PET film/adhesive film/second end of second PET film, in which a contact area between each of the first and second PET films and the adhesive film is the size of the adhesive film, that is, 20 mm×20 mm.

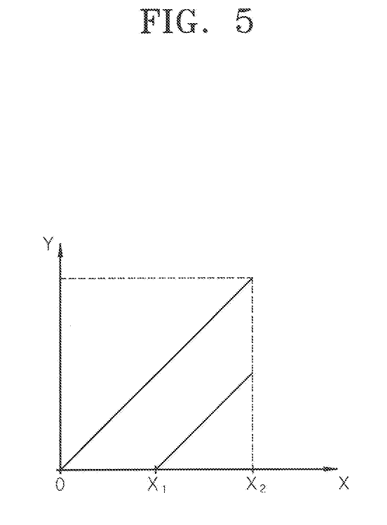

FIG. 5 is a graph in which the X-axis is a stretched length of the adhesive film, and the Y-axis is a force applied to the adhesive film in measurement of restoration force. The adhesive film may have the initial length X₀ of 10 μm to 200 μm. Restoration force can be measured using a TA.XT_Plus Texture Analyzer (Stable Micro System Co., Ltd.).

Herein, an adhesive film according to an embodiment of the present Invention will be described.

An adhesive film according to an embodiment of the present invention (hereinafter, “adhesive film”) includes a (meth)acrylic copolymer having a hydroxyl group and formed of a monomer mixture including a hydroxyl group-containing (meth)acrylate and an alkyl group-containing (meth)acrylate. The adhesive film has a glass transition temperature of about −35° C. or less. The adhesive film allows about 50,000 cycles or more of bending before delamination between the adhesive film and a PET film, cracking, or bubble generation occurs in the foldability evaluation under conditions of at least one of i) −20° C., and ii) 60° C. and 93% RH. When the adhesive film allows about 50,000 cycles or more of bending, and, in an embodiment, about 60,000 to about 200,000 cycles of bending, before delamination between the adhesive film and the PET film, cracking, or bubble generation occurs in foldability evaluation under the conditions of at least one of i) −20° C., and ii) 60° C. and 93% RH, the adhesive film can secure high reliability in a flexible display. No bubble generation means the bubble generation area ratio of 0%. Particularly, the adhesive film exhibits good foldability not only when the adhesive film is used alone, but also when the adhesive film is stacked together with a plurality of optical films as in the foldability evaluation. Further, the adhesive film exhibits good foldability under conditions of both i) −20° C., and ii) 60° C. and 93% RH.

The adhesive film may include the (meth)acrylic copolymer having a hydroxyl group; and at least one of a macro-monomer and organic nanoparticles, and has a glass transition temperature of about −35° C. or less, thereby allowing about 50,000 cycles or more of bending in which the adhesive film has the bubble generation area of 0% in the foldability evaluation under conditions of −20° C., or 60° C. and 93% RH. In an embodiment, the adhesive film may have a glass transition temperature of about −35° C. or less, and, in an embodiment, about −60° C. to about −35° C. Within this range, the adhesive film can exhibit good foldability when stacked together with optical members or optical films under the conditions of at least one of i) −20° C., and ii) 60° C. and 93% RH. For example, the adhesive film may have a glass transition temperature of about −60° C., −59° C. , −58° C., −57° C., −58° C., −55° C., −54° C., −53° C., −52° C., −51° C., −50° C., −49° C., −48° C. , −47° C., −46° C., −45° C., −44° C., −43° C., −42° C., −41° C., −40° C., −39° C., −38° C. , −37° C., −36° C., or −35° C..

The adhesive film includes the (meth)acrylic copolymer having a hydroxyl group; and at least one of the macro-monomer and the organic nanoparticles, thereby improving reliability and peel strength by reducing a modulus difference between low temperature and high temperature. The (meth)acrylic copolymer having a hydroxyl group, the macro-monomer, and the organic nanoparticles will be described in more detail below.

The adhesive film may have the restoration force at 25C of about 60% or more, and, in an embodiment about 80% or more, and, in an embodiment, about 80% to about 95%, for example, about 60%, 61%, 62%, 63%, 64%, 65%, 66%, 67%, 68%, 69%. 70%, 71%. 72%, 73%, 74%, 75%, 76%, 77%, 78%, 79%, 80%. 81%, 82%, 83%, 84%, 85%, 86%, 87%, 88%. 89%. 90%, 91%, 92%, 93%, 94%, or 95%. The restoration force is obtained by measuring the degree of recovery when recovered to an original state after the adhesive film stacked on optical films or optical members is folded for a certain period of time. The adhesive film including at least one of the macro-monomer and the organic nanoparticles and having a restoration force within the above range can exhibit good foldability when stacked together with the optical members or the optical films under the conditions of at least one of i) −20° C., and ii) 60° C. and 93% RH.

The adhesive film may have a ratio (modulus at 80° C.: modulus at −20° C.) of modulus at 80° C. to modulus at −20° C. of about 1:1 to about 1:10, and, in an embodiment, about 1:1 to about 1:8, and, in an embodiment, about 1:1 to about 1:6, for example, about 1:1, about 1:2, about 1:3, about 1:4, about 1:5, about 1:6, about 1:7, about 1:8, about 1:9, or about 1:10. Within this range, the adhesive film can exhibit good reliability due to a small difference in modulus between low temperature and high temperature, can improve life span of an optical display, can prevent or substantially prevent deterioration in adhesion between adherends in a wide temperature range (e.g., −20° C. to 80° C.), and can be used in a flexible optical display.

The adhesive film may have a modulus at 80° C. of about 10 kPa to about 500 kPa, and, in an embodiment, about 10 kPa to about 300 kPa: for example, about 10 kPa, 20 kPa, 30 kPa, 40 kPa, 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, 200 kPa, 210 kPa, 220 kPa, 230 kPa, 240 kPa, 250 kPa, 260 kPa, 270 kPa, 280 kPa, 290 KPa, 300 kPa, 310 kPa, 320 kPa, 330 kPa, 340 kPa, 350 kPa, 360 kPa, 370 kPa, 380 kPa, 390 kPa, 400 kPa, 410 kPa, 420 kPa, 430 kPa, 440 kPa, 450 kPa, 460 kPa, 470 kPa, 480 kPa, 490 kPa, or 500 kPa. Within this range, the adhesive film can exhibit improved reliability at high temperature.

The adhesive film may have a modulus at −20° C. of about 10 kPa to about 500 kPa, and, in an embodiment, about 20 kPa to about 500 kPa, for example, about 10 kPa, 20 kPa, 30 kPa, 40 kPa, 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, 200 kPa, 210 kPa, 220 kPa, 230 kPa, 240 kPa, 250 kPa, 260 kPa, 270 kPa, 280 kPa, 290 kPa, 300 kPa, 310 kPa, 320 kPa, 330 kPa, 340 kPa, 350 kPa, 360 kPa, 370 kPa, 380 kPa, 390 kPa, 400 kPa, 410 kPa, 420 kPa, 430 kPa, 440 kPa, 450 kPa, 460 kPa, 470 kPa, 480 kPa, 490 kPa, or 500 kPa. Within this range, the adhesive film can exhibit viscoelasticity at room temperature and has good restoration force.

The adhesive film may have a modulus at 25° C. of about 25 kPa to about 500 kPa, and, in an embodiment, about 25 kPa to about 300 kPa, for example, about 25 kPa, 30 kPa, 40 kPa, 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, 200 kPa, 210 kPa, 220 kPa, 230 kPa, 240 kPa, 250 kPa, 260 kPa, 270 kPa, 280 kPa, 290 kPa, 300 kPa, 310 kPa, 320 kPa, 330 kPa, 340 kPa, 350 kPa, 360 kPa, 370 kPa, 380 kPa, 390 kPa, 400 kPa, 410 kPa, 420 kPa, 430 kPa, 440 kPa, 450 kPa, 460 kPa, 470 kPa, 480 kPa, 490 kPa, or 500 kPa. Within this range, the adhesive film can exhibit viscoelasticity at room temperature and has good restoration force while exhibiting good foldability.

The adhesive film may have a peel strength at 25° C. of about 700 gf/in or more, and, in an embodiment, about 900 gf/in or more, and, in an embodiment, about 900 gf/in to about 3000gf/in, for example, about 700 gf/in, 800 gf/in, 900 gf/in, 1,000 gf/in, 1,100 gf/in, 1,200 gf/in, 1,300 gf/in, 1,400 gf/in, 1,500 gf/in, 1,600 gf/in, 1,700 gf/in, 1,800 gf/in, 1,900 gf/in, 2,000 gf/in, 2,100 gf/in, 2,200 gf/in, 2,300 gf/in, 2,400 gf/in, 2,500 gf/in, 2,600 gf/in, 2,700 gf/in, 2,800 gf/in, 2,900 gf/in, or 3,000 gf/in. Within this range of peel strength, the adhesive film can exhibit good reliability due to less delamination between the adhesive film and an adherend when used in a flexible display.

The adhesive film may have a haze of about 2% or less, and, in an embodiment, about 0.1% to about 1%, and a total luminous transmittance of about 90% or more, and, in an embodiment, about 95% to about 99%, in the visible range (for example: in a wavelength range of 380 nm to 780 nm). Within this range, the adhesive film can exhibit good optical transparency to be used in an optical display.

The adhesive film may have a thickness of about 10 μm to about 300 μm, and, in an embodiment, about 15 μm to about 175 μm. Within this range, the adhesive film can be used in an optical display.

The adhesive film may have a dielectric constant of about 1.8 to about 3.0 at 1 MHz. Within this range, the adhesive film allows a display apparatus to be driven without failure when stacked on a transparent conductive film in a touch panel.

The adhesive film according to the embodiment may be formed by photo-curing of an adhesive composition. The adhesive composition may include a monomer mixture for a (meth)acrylic copolymer having a hydroxyl group; and at least one of a macro-monomer and organic nanoparticles. In the adhesive composition, the monomer mixture may be used as a non-polymerized monomer mixture or may be used as a partially polymerized monomer mixture.

The monomer mixture can form the (meth)acrylic copolymer having a hydroxyl group. The (meth)acrylic copolymer having a hydroxyl group can form a matrix of the adhesive film and exhibit adhesive properties. The (meth)acrylic copolymer having a hydroxyl group may have a glass transition temperature of about −100° C. to about −10° C., and, in an embodiment, about −70° C. to about −30° C., for example, about −100° C., −90° C., −80° C., −70° C., −60° C., −50° C., −40° C., −30° C., −20° C., or −10° C. Within this range, the adhesive film can exhibit good adhesion and reliability in a wide temperature range.

The (meth)acrylic copolymer having a hydroxyl group may have a refractive index of about 1.40 to about 1.70, and, in an embodiment, about 1.45 to about 1.60, for example, about 1.40, 1.50, 1.60, or 1.70. Within this range, the adhesive film can maintain transparency when stacked on other optical films. The monomer mixture may include a hydroxyl group-containing (meth)acrylate and an alkyl group-containing (meth)acrylate.

The hydroxyl group-containing (meth)acrylate can provide adhesive strength to the adhesive film. The hydroxyl group-containing (meth)acrylate may be a (meth)acrylate having at least one hydroxyl group. For example, the hydroxyl group-containing (meth)acrylate may include at least one of 2-hydroxyethyl (meth)acrylate, 2-hydroxypropyl (meth)acrylate, 3-hydroxypropyl(meth)acrylate, 2-hydroxybutyl (meth)acrylate, 4-hydroxybutyl (meth)acrylate, 6-hydroxyhexyl (methyacrylate, 1,4-cyclohexanedimethanol mono(meth)acrylate, 1-chloro-2-hydroxypropyl (methyacrylate, diethylene glycol mono(meth)acrylate, 1,6-hexanediol mono(meth)acrylate, pentaerythritol tri(meth)acrylate, dipentaerythritol penta(meth)acrylate, neopentylglycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexanedimethanol mono(meth)acrylate. Particularly, as the hydroxyl group-containing (meth)acrylate, a (meth)acrylate containing a C₂ to C₄ alkyl group having at least one hydroxyl group, for example, 3-hydroxypropy( (meth)acrylate, 4-hydroxybutyl (meth)acrylate, or the like, can significantly improve foldability of the adhesive film in the foldability evaluation under conditions of −20° C., and/or 60° C. and 93% RH.

The hydroxyl group-containing (meth)acrylate may be present in an amount of about 10 wt % to about 30 wt %, and, in an embodiment, about 12 wt % to about 25 wt % and, in an embodiment, about 15 wt % to about 25 wt %, for example, about 10 wt %, 11 wt %, 12 wt %, 13 wt %, 14 wt %, 15 wt %, 16 wt %, 17 wt %, 18 wt %, 19 wt %, 20 wt %, 21 wt %. 22 wt %, 23 wt %, 24 wt %, 25 wt %, 26 wt %, 27 wt %, 28 wt %, 29 wt %, or 30 wt %, in the monomer mixture. Within this range, the adhesive film can exhibit good properties in terms of adhesion, durability, and foldability, and has a small difference in modulus between high temperature and low temperature to provide good reliability. Particularly, when the hydroxyl group-containing (meth)acrylate is present in an amount of about 15 wt % to about 25 wt % in the monomer mixture, the adhesive film can exhibit further improved foldability at low temperature and under high temperature/humidity conditions.

The alkyl group-containing (meth)acrylate can form a matrix of the adhesive film. The alkyl group-containing (meth)acrylate may include an unsubstituted C₁ to C₂₀ linear or branched alkyl (meth)acrylic acid ester. For example, the alkyl group-containing (meth)acrylate may include at least one of methyl (meth)acrylate, ethyl (meth)acrylate, propyl (meth)acrylate, n-butyl (meth)acrylate, t-butyl (meth)acrylate, iso-butyl (methyacrylate, pentyl (meth)acrylate, hexyl (meth)acrylate, heptyl (meth)acrylate, ethylhexyl (meth)acrylate, octyl (meth)acrylate, isooctyl (meth)acrylate, nonyl (methyacrylate, decyl (meth)acrylate, lauryl (meth)acrylate, and isobornyl (meth)acrylate. Particularly, as the alkyl group-containing (meth)acrylate, a (meth)acrylate containing a C₄ to C₈ alkyl group, for example, butyl (meth)acrylate, ethylhexyl (meth)acrylate, or the like, can significantly improve foldability of the adhesive film in foldability evaluation under conditions of −20° C., and/or 60° C. and 93% RH.

The alkyl group-containing (meth)acrylate may be present in an amount of about 70 wt % to about 90 wt %, and, in an embodiment, about 75 wt % to about 88 wt %, and, in an embodiment, about 75 wt % to about 85 wt %, for example, about 70 wt %, 71 wt %, 72 wt %, 73 wt %, 74 wt %, 75 wt %, 76 wt %, 77 wt %, 78 wt %, 79 wt %. 80 wt %, 81 wt %, 82 wt %, 83 wt %, 84 wt %, 85 wt %, 86 wt %, 87 wt %, 88 wt %, 89 wt %, or 90 wt %. in the monomer mixture. Within this range, the adhesive film can exhibit further improved adhesion and reliability.

The monomer mixture may further include a copolymerizable monomer. The copolymerizable monomer may provide additional effects to the (meth)acrylic copolymer, the adhesive composition, or the adhesive film. The copolymerizable monomer is a different monomer than the hydroxyl group-containing (meth)acrylate and the alkyl group-containing (meth)acrylate. The copolymerizable monomer may include at least one of an ethylene oxide-containing monomer, a propylene oxide-containing monomer, an amine group-containing monomer, an alkoxy group-containing monomer, a phosphate group-containing monomer, a sulfonic acid group-containing monomer, a phenyl group-containing monomer, a silane group-containing monomer, a carboxylic acid group-containing monomer, and an amide group-containing (meth)acrylate.

The ethylene oxide-containing monomer may include at least one (meth)acrylate monomer containing an ethylene oxide group (—CH₂CH₂O—). For example, the ethylene oxide-containing monomer may include any of polyethylene oxide alkyl ether (meth)acrylates, such as polyethylene oxide monomethyl ether (meth)acrylate, polyethylene oxide monoethyl ether (meth)acrylate, polyethylene oxide monopropyl ether (meth)acrylate, polyethylene oxide monobutyl ether (meth)acrylate, polyethylene oxide monopentyl ether (meth)acrylate, polyethylene oxide dimethyl ether (meth)acrylate, polyethylene oxide diethyl ether (meth)acrylate, polyethylene oxide monoisopropyl ether (meth)acrylate, polyethylene oxide monoisobutyl ether (meth)acrylate, and polyethylene oxide mono-tert-butyl ether (meth)acrylate, without being limited thereto.

The propylene oxide-containing monomer may include a polypropylene oxide alkyl ether (meth)acrylate, such as any of polypropylene oxide monomethyl ether (meth)acrylate, polypropylene oxide monoethyl ether (meth)acrylate, polypropylene oxide monopropyl ether (meth)acrylate, polypropylene oxide monobutyl ether (meth)acrylate, polypropylene oxide monopentyl ether (meth)acrylate, polypropylene oxide dimethyl ether (meth)acrylate, polypropylene oxide diethyl ether (meth)acrylate, polypropylene oxide monoisopropyl ether (meth)acrylate, polypropylene oxide monoisobutyl ether (meth)acrylate, and polypropylene oxide mono-tert-butyl ether (meth)acrylate, without being limited thereto.

The amine group-containing monomer may include any of amine group-containing (meth)acrylic monomers, such as monomethylaminoethyl (meth)acrylate, monoethylaminoethyl (meth)acrylate, monomethylaminopropyl (meth)acrylate, monoethylaminopropyl (meth)acrylate, dimethytaminoethyl (meth)acrylate, diethylaminoethyl (meth)acrylate, N-tert-butylaminoethyl (meth)acrylate, and (meth)acryloxyethyltrimethyl ammonium chloride (meth)acrylate, without being limited thereto.

The alkoxy group-containing monomer may include any of 2-methoxy ethyl (meth)acrylate, 2-methoxypropyl (meth)acrylate, 2-ethoxypropyl (meth)acrylate, 2-butoxypropyl (meth)acrylate, 2-methoxypentyl (meth)acrylate, 2-ethoxypentyl (meth)acrylate, 2-butoxyhexyl (meth)acrylate, 3-methoxypentyl (meth)acrylate, 3-ethoxypentyl (meth)acrylate, and 3-butoxyhexyl (meth (acrylate, without being limited thereto.

The phosphate group-containing monomer may include any of phosphate group-containing acrylic monomers, such as 2-methacryloyloxyethyldiphenylphosphate (meth)acrylate, trimethacryloyloxyethylphosphate (meth)acrylate, and triacryloyloxyethylphosphate (meth)acrylate, without being limited thereto.

The sulfonic acid group-containing monomer may include any of sulfonic acid group-containing acrylic monomers, such as sodium sulfopropyl (meth)acrylate, sodium 2-sulfoethyl (meth)acrylate, and sodium 2-acrylamido-2-methylpropane sulfonate, without being limited thereto.

The phenyl group-containing monomer may include any of phenyl group-containing acrylic vinyl monomers, such as p-tert-butylphenyl (meth)acrylate, o-biphenyl (meth)acrylate, and phenoxyethyl (meth)acrylate, without being limited thereto.

The silane group-containing monomer may include any of silane group-containing vinyl monomers, such as 2-acetoacetoxyethyl (meth)acrylate, vinyltrimethoxysilane, vinyitriethoxysilane, vinyl tris(2-methoxyethyl)silane, vinyltriacetoxysilane, and (meth)acryloyloxypropyltrimethoxysilane, without being limited thereto.

The carboxylic acid group-containing monomer may include any of (meth)acrylic acid, 2-carboxyethyl (meth)acrylate, 3-carboxypropyl (meth)acrylate, 4-carboxybutyl (meth)acrylate, itaconic acid, crotonic acid, maleic acid, fumaric acid, and maleic anhydride, without being limited thereto.

The amide group-containing monomer may include at least one selected from among (meth)acrylamide, N-methyl (meth)acrylamide, N-methylol (meth)acrylamide, N-methoxymethyl (meth)acrylamide, N,N-methylene bis(meth)acrylamide, N-hydroxyethyl (meth)acrylamide, and N,N-diethyl (meth)acrylamide. Particularly, N-hydroxyethyl (meth)acrylamide and N,N-diethyl (meth)acrylamide may help realize the effects of the present invention and can secure good compatibility with the alkyl group-containing (meth)acrylate and the hydroxyl group-containing (meth)acrylate.

The copolymerizable monomer may be present in an amount of about 10 wt % or less, and, in an embodiment, about 7 wt % or less, and, in an embodiment, about 0.05 wt % to about 10 wt %, in the monomer mixture. Within this range, the adhesive composition can further improve adhesive strength and durability of the adhesive film. The carboxylic acid group-containing monomer may be present in an amount of about 5 wt % or less, and, in an embodiment, about 3 wt % or less, and, in an embodiment, about 1 wt % or less, in the monomer mixture. Within this range, the adhesive composition can further improve adhesive strength and durability of the adhesive film,

The organic nanoparticles may have an average particle diameter of about 10 nm to about 400 nm, and, in an embodiment, about 10 nm to about 300 nm, and, in an embodiment, about 50 nm to about 150 nm, for example, about 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm. 350 nm, 360 nm, 370 nm, 380 nm, 390 nm, or 400 nm. Within this range, the organic nanoparticles can be prevented or substantially prevented from agglomerating, may not affect foldability of the adhesive film, and can secure good transparency of the adhesive film, even with a difference in a refractive index between the organic nanoparticles and the adhesive film described below.

A difference in refractive index between the organic nanoparticles and the (meth)acrylic copolymer having a hydroxyl group may be about 0.1 or less, and, in an embodiment, about 0 to about 0.05, and, in an embodiment, about 0 to about 0.02, for example, about 0, 0.01, 0.02, 0.03, 0.04, 0.05, 0.06, 0.07, 0.08, 0.09, or 0.1. Within this range, the adhesive film can exhibit good transparency.

The organic nanoparticles may have a refractive index of about 1.40 to about 1.70, and, in an embodiment, about 1.45 to about 1.60, for example, about 1.40, about 1.50, about 1.60, or about 1.70. Within this range, the adhesive film can exhibit good transparency.

The organic nanoparticles may have a core-shell structure or a simple structure, such as bead type nanoparticles, without being limited thereto. In an embodiment, the organic nanoparticles may have a core-shell structure, in which the core and the shell satisfy Equation 2 below. That is, the organic nanoparticles may include nanoparticles in which each of the core and the shell is formed of organic materials. With the organic nanoparticles having the core-shell structure, the adhesive film can exhibit good foldability and effective balance between elasticity and flexibility.

Tg(c)<Tg(s), <Equation 2>

where Tg(c) is the glass transition temperature (unit: ° C.) of the core, and Tg(s) is the glass transition temperature (unit: ° C.) of the shell.

Herein, the term “shell” means an outermost layer of the organic nanoparticle. The core may be a spherical particle. In one or more embodiments, the core may include an additional layer surrounding the spherical particle so long as the core has a glass transition temperature satisfying the above Equation 2.

The core may have a glass transition temperature of about −150° C. to about 10° C., and, in an embodiment, about −150° C. to about −5° C., and, in an embodiment, about −150° C. to about −20° C., for example, about −150° C., −140° C., −130° C., −120° C., −110° C., −100° C., −90° C., −80° C., −70° C., −60° C., −50° C., −40° C., −30° C., −20° C., −10° C., 0° C., or 10° C.. Within this range, the adhesive film can have good viscoelasticity at low temperature and/or at room temperature. The core may include at least one of a poly(alkyl (meth)acrylate), a polybutadiene and a polysiloxane, each having a glass transition temperature within this range.

The poly(alkyl (meth)acrylate) may include at least one of poly(methyl acrylate), poly(ethyl acrylate), poly(propyl acrylate), poly(butyl acrylate), poly(isopropyl acrylate), poly(hexyl acrylate), poly(hexyl methacrylate), poly(ethylhexyl acrylate), and poly(ethylhexyl methacrylate), without being limited thereto.

The polysiloxane may be, for example, an organosiloxane (co)polymer. The organosiloxane (co)polymer may be a non-cross-linked or cross-linked organosiloxane (co)polymer. The cross-linked organosiloxane (co)polymer may be used to secure impact resistance and colorability. The cross-linked organosiloxane (co)polymer may include any of cross-linked dimethylsiloxane, methylphenylsiloxane, diphenylsiloxane, and mixtures thereof. With a copolymer of two or more organosiloxanes, the nanoparticles can have a refractive index of about 1.41 to about 1.50.

A cross-linked state of the organosiloxane (co)polymer can be determined based on the degree of dissolution in various organic solvents. As the degree of crosslinking of the organosiloxane (co)polymer intensifies, the degree of dissolution of the organosiloxane (co)polymer is reduced. A solvent for determination of the cross- linked state may include acetone, toluene, and the like. The organosiloxane (co)polymer may have a moiety which is not dissolved in acetone or toluene. The organosiloxane copolymer may include about 30% or more of insolubles in toluene.

The organosiloxane (co)polymer may further include an alkyl acrylate cross- linked polymer. The alkyl acrylate cross-linked polymer may include any of methyl acrylate, ethyl acrylate, n-butyl acrylate, 2-ethylhexyl acrylate, and the like. For example, the alkyl acrylate cross-linked polymer may be n-butyl acrylate or 2-ethylhexyl acrylate having a low glass transition temperature.

The shell may have a glass transition temperature of about 15° C. to about 150° C., and, in an embodiment, about 35° C. to about 150° C., and, in an embodiment, about 50° C. to about 140° C., for example, about 15° C., 20° C., 30° C., 40° C., 50° C., 60° C., 70° C., 80° C., 90° C., 100° C., 110° C., 120° C., 130° C., 140° C., or 150° C.. Within this range, the organic nanoparticles can exhibit good dispersion in the (meth)acrylic copolymer. The shell may include poly(alkyl methacrylate) having a glass transition temperature within this range. For example, the shell may include at least one of poly(methyl methacrylate) (PMMA), poly(ethyl methacrylate), poly(propyl methacrylate), poly(butyl methacrylate), poly(isopropyl methacrylate), poly(isobutyl methacrylate), and poly(cyclohexyl methacrylate), without being limited thereto.

The core may be present in an amount of about 30 wt % to about 99 wt %, and, in an embodiment, 40 wt % to 95 wt %, and, in an embodiment, about 50 wt % to about 90 wt %, for example, about 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or 99 wt %, in the organic nanoparticles. Within this range, the adhesive film can exhibit good foldability in a wide temperature range. The shell may be present in an amount of about 1 wt % to about 70 wt %, and, in an embodiment, about 5 wt % to about 60 wt %, and, in an embodiment, about 10 wt % to about 50 wt %, for example, about 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, or 70 wt %, in the organic nanoparticles. Within this range, the adhesive film can exhibit good foldability in a wide temperature range.

The organic nanoparticles may be present in an amount of about 0.1 parts by weight to about 20 parts by weight, and, in an embodiment, about 0.5 parts by weight to about 10 parts by weight, and, in an embodiment, about 0.5 parts by weight to about 5 parts by weight, for example, about 0.1, 1, 2, 3, 4, 5, 6, 7, 8, 9, 10, 11, 12, 13, 14, 15, 16, 17, 18, 19, or 20 parts by weight, relative to 100 parts by weight of the monomer mixture. Within this range, the organic nanoparticles can secure good properties in terms of modulus of the adhesive film at high temperature, foldability of the adhesive film at room temperature and high temperature, and viscoelasticity of the adhesive film at low temperature and/or room temperature.

The organic nanoparticles may be prepared by typical emulsion polymerization, suspension polymerization, or solution polymerization.

The macro-monomer can be polymerized with the monomer mixture to form the (meth)acrylic copolymer having a hydroxyl group, thereby improving strength of the adhesive film. The macro-monomer can improve peel strength of the adhesive film, even when the adhesive film has a thin thickness. For example, the macro-monomer allows the adhesive film to exhibit peel strength within the above range, even when the adhesive film has a thickness of 10 μm to 50 μm. The macro-monomer has a functional group that can be cured by active energy rays, and can be polymerized with the hydroxyl group-containing (meth)acrylate and the alkyl group-containing (meth)acrylate. In an embodiment, the macro-monomer can be represented by Formula 1:

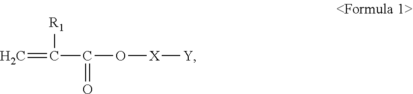

where R₁ is hydrogen or a methyl group, X is a single bond or a bivalent coupling group, and Y is a polymer chain obtained by one or two selected from among methyl (meth)acrylate, ethyl (meth)acrylate, n-butyl (meth)acrylate, iso-butyl (meth)acrylate, t-butyl (meth)acrylate, styrene, and (meth)acrylonitrile.

The macro-monomer may have a number average molecular weight of about 2,000 to about 20,000, and, in an embodiment, about 2,000 to about 10,000, and, in an embodiment, about 4,000 to about 8,000, for example, about 2,000, 3,000, 4,000, 5,000, 6,000, 7,000, 8,000, 9,000, 1,0000, 11,000, 12,000, 13,000, 14,000, 15,000, 16,000, 17,000, 18,000, 19,000, or 20,000. Within this range, the adhesive composition can exhibit sufficient adhesive strength and good thermal resistance while suppressing deterioration in workability due to increase in viscosity of the adhesive composition.

The macro-monomer may have a glass transition temperature of about 40° C. to about 150° C., and, in an embodiment, about 60° C. to about 140° C., and, in an embodiment, about 80° C. to about 130° C., for example, about 40° C., 50° C., 60° C., 70° C., 80° C., 90° C., 100° C., 110° C., 120° C., 130° C., 140° C., or 150° C.. Within this range, the adhesive film can exhibit sufficient cohesion and can suppress deterioration in tack or adhesion.

The bivalent coupling group may be a C₁ to C₁₀ alkylene group, a C₇ to C₁₃ arylalkylene group, a C₆ to C₁₂ arylene group, —NR²— (R² being hydrogen or a C₁ to C₅ alkyl group), or a group derived from COO—, —O—, —S—, —SO₂NH—, —NHSO₂—, —NHCOO—, —OCONH, or a hetero ring, in addition, the bivalent coupling group may be represented by Formulas 1a to 1d:

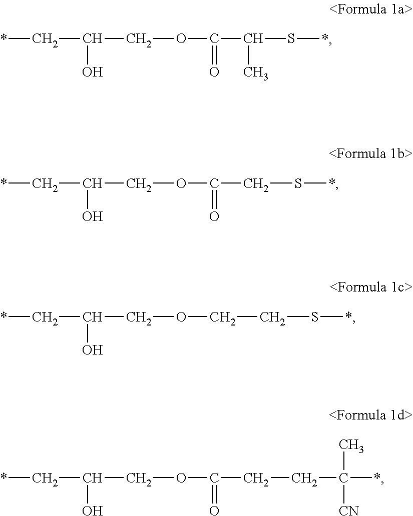

where * is a connection site of an element.

The macro-monomer may be obtained from commercially available products. For example, the macro-monomer may include any of a macro-monomer in which a segment corresponding to Y is methyl methacrylate, a macro-monomer in which a segment corresponding to Y is styrene, a macro-monomer in which a segment corresponding to Y is styrene/acrylonitrile, and a macro-monomer in which a segment corresponding to Y is butyl acrylate, all of which have a methacryloyl group at a terminal thereof.

The macro-monomer may be present in an amount of about 0.1 parts by weight to about 20 parts by weight, and, in an embodiment, about 0.5 parts by weight to about 10 parts by weight, and, in an embodiment, about 0.5 parts by weight to about 5 parts by weight, for example, about 0.1, 1, 2, 3, 4, 5, 6, 7, 8, 9, 10, 11, 12, 13, 14, 15, 16, 17, 18, 19, or 20 parts by weight, relative to 100 parts by weight of the monomer mixture. Within this range, the adhesive film can have property balance between viscoelasticity, modulus, and restoration force, and can prevent or substantially prevent increase in haze.

The adhesive composition may further include at least one of an initiator, a crosslinking agent, and a silane coupling agent.

The initiator may be used to form a (meth)acrylic copolymer by curing (e.g., partially polymerizing) the monomer mixture, or to cure a viscous liquid into a film. The initiator may include at least one of a photopolymerization initiator and a heat polymerization initiator.

The photopolymerization initiator may be any initiator so long as the initiator can induce polymerization of a radical polymerizable compound during curing through light irradiation. For example, the photopolymerization initiator may include any of benzoin, acetophenone, hydroxy ketone, amino ketone, phosphine oxide photoinitiators, and the like. The photopolymerization initiator may include any of benzoin, benzoin methyl ether, benzoin ethyl ether, benzoin isopropyl ether, benzoin n-butyl ether, benzoin isobutyl ether, acetophenone compounds such as 2,2-dimethoxy-2-phenylacetophenone, 2,2′-diethoxyacetophenone, 2,2′-dibutoxyacetophenone, 2-hydroxy-2-methylpropiophenone, p-t-butyl trichloroacetophenorie, p-t-butyl dichloroacetophenone, 4-chloroacetophenone, 2,2′-dichloro-4-phenoxyacetophenone dimethylamino acetophenone, 2,2-dimethoxy-2-phenylacetophenone, 2,2-diethoxy-2-phenylacetophenone, 2-hydroxy-2-methyl-1-phenylpropan-1-one, 2-benzyl-2-dimethyl amino-1-(4-morpholinophenyl)-butane-1-one, 1-hydroxycyclohexylphenylketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-dlethylaminobenzophenone, dichlorobenzophenone, 2-methylanthraquinone, 2-ethylanthraquinone, 2-t-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethylketal, acetophenone dimethylketal, p-dimethylamino benzoic acid ester, oligo[2-hydroxy-2-methyl-1-[4-(1-methylvinyl)phenyl]propanone], and 2,4,6-trimethylbenzoyl-diphenyl-phosphine oxide, without being limited thereto. These photopolymerization initiators may be used alone or in combination thereof.

The heat polymerization initiator may be any typical initiator, for example, azo, peroxide and redox compounds, so long as the initiator can realize the above properties. Examples of the azo compound may include 2,2-azobis(2-methylbutyronitrile), 2,2-trilazobis(isobutyronitrile), 2,2-trilazobis(2,4-dimethylvaleronitrile), 2,2-nitazobis-2-hydroxymethylpropionitrile, dimethyl-2,2-methylazobis(2-methylpropionate), and 2,2-pioazobis(4-methoxy-2,4-dimethylvaleronitrile), without being limited thereto. Examples of the peroxide compound may include: inorganic peroxides, such as potassium perchlorate, ammonium persulfate, and hydrogen peroxide; and organic peroxides, such as diacetylperoxide, peroxy dicarbonate, peroxy ester, tetramethylbutyl peroxy neodecanoate, bis(4-butylcyclohexyl)peroxydicarbonate, di(2-ethylhexyl)peroxy carbonate, butylperoxy peroxyneodecanoate, dipropyl peroxydicarbonate, diisopropyl peroxydicarbonate, diethoxyethyl peroxydicarbonate, diethoxyhexyl peroxydicarbonate, hexyl peroxydicarbonate, dimethoxybutyl peroxydicarbonate, bis(3-methoxy-3-methoxybutyl) peroxydicarbonate, dibutyl peroxydicarbonate, dicetyl peroxydicarbonate, dimyristyl peroxydicarbonate, 1,1,3,3-tetramethylbutyl peroxypivalate, hexyl peroxypivalate, butyl peroxypivalate, trimethylhexanoyl peroxide, dimethyl hydroxybutyl peroxyneodecanoate, amyl peroxyneodecanoate, butyl peroxyneodecanoate, t-butylperoxy neoheptanoate, amyl peroxypivalate, t-butyl peroxypivalate, t-amyl peroxy-2-ethylhexanoate, lauroyl peroxide, dilauroyl peroxide, didecanoyl peroxide, benzoyl peroxide, and dibenzoyl peroxide, without being limited thereto. Examples of the redox compound may include mixtures of a peroxide compound and a reductant, without being limited thereto. These azo, peroxide and redox compounds may be used alone or in combination thereof.

The initiator may be present in an amount of about 0.0001 parts by weight to about 5 parts by weight, and, in an embodiment, about 0.001 parts by weight to about 3 parts by weight, and, in an embodiment, about 0.001 parts by weight to about 1 part by weight, relative to 100 parts by weight of the monomer mixture which, forms the (meth)acrylic copolymer. Within this range, foe initiator allows complete curing of the adhesive composition, can prevent or substantially prevent deterioration in transmittance of the adhesive film due to residual initiator, can reduce bubble generation, and can exhibit good reactivity.

The crosslinking agent can increase mechanical strength of foe adhesive film through improvement in crosslinking degree of the adhesive composition. The crosslinking agent may include a polyfunctional (meth)acrylate capable of being cured by active energy rays. The crosslinking agent may include any of: bifunctional acrylates, such as 1,4-butanediol di(meth)acrylate, 1,6-hexanediol di(meth)acrylate, neopentylglycol di(meth)acrylate, polyethyleneglycol di(meth)acrylate, neopentylglycol adipate di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecane dimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentylglycol-modified trimethylpropane di(meth)acrylate, adamantane di(meth)acrylate, and 9,9-bis[4-(2-acryloyloxyethoxy)phenyl]fluorine: trifunctional acrylates, such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylates, tris(meth)acryloxyethyl isocyanurate; tetrafunctional acrylates such as diglycerin tetra(meth)acrylate and pentaerythritol tetra(meth)acrylate; pentafunctional acrylates, such as dipentaerythritol penta(meth)acrylate; and hexafunctional acrylates, such as dipentaerythritol hexa(meth)acrylate, caprolactone-modified dipentaerythritol hexa(meth)acrylate, and urethane (meth)acrylates (for example, reaction products of an isocyanate monomer and trimethylolpropane tri(meth)acrylate), without being limited thereto. These crosslinking agents may be used alone or in combination thereof. In an embodiment, the crosslinking agent is a polyfunctional (meth)acrylate of polyhydric alcohol.

The crosslinking agent may be optionally present in an amount of about 0.001 parts by weight to about 5 parts by weight, and, in an embodiment, about 0.003 parts by weight to about 3 parts by weight, and, in an embodiment, about 0.005 parts by weight to about 1 part by weight, relative to 100 parts by weight of the monomer mixture which forms the (meth)acrylic copolymer. Within this range, the adhesive film exhibits good adhesion and Improved reliability.

The adhesive composition may further include a silane coupling agent. The silane coupling agent serves to allow the adhesive film to exhibit good reliability without bubbling or delamination, even after being left in a frame having a predetermined radius of curvature under high temperature/humidity conditions for a predetermined period of time. The silane coupling agent may be a typical silane coupling agent known to those skilled in the art. For example, the silane coupling agent may include at least one selected from the group consisting of epoxylated silicon compounds, such as 3-glycidoxypropyltrimethoxysilane, 3-glycidoxypropyltrmethoxysilane, 3-glycidoxypropylmethyldimethoxysilane, and 2-(3,4-epoxycyclohexyl)ethyltrimethoxysilane; polymerizable unsaturated group-containing silicon compounds, such as vinyltrimethoxysilane, vinyltriethoxysilane, and (meth)acryloxypropyltrimethoxysilane; amino group-containing silicon compounds, such as 3-aminopropyltrimethoxysilane, N-(2-aminoethyl)-3-aminopropyltrimethoxysilane, and N-(2-aminoethyl)-3-aminopropylmethyldimethoxysilane; and 3-chloropropyltrimethoxysilane, without being limited thereto. In an embodiment, the silane coupling agent is an epoxylated silane coupling agent.

The silane coupling agent may be present in an amount of about 0.01 parts by weight to about 3 parts by weight, and, in an embodiment, about 0.01 parts by weight to about 1 part by weight, relative to 100 parts by weight of the monomer mixture which forms the (meth)acrylic copolymer. Within this range, the silane coupling agent can secure reliability of the adhesive film in a bent state under high temperature/humidity conditions as described above, and can provide a small difference in peel strength between low temperature, room temperature, and high temperature.

The adhesive composition may further include any of typical additives, such as curing accelerators, ionic liquids, lithium salts, inorganic fillers, softeners, molecular weight regulators, antioxidants, anti-aging agents, stabilizers, adhesion-imparting resins, reforming resins (e.g., polyol, phenol, acrylic, polyester, polyolefin, epoxy, epoxidized polybutadiene resins, and the like), leveling agents, defoamers, plasticizers, dyes, pigments (e.g., coloring pigments, extender pigments, and the like), processing agents, UV blocking agents, fluorescent whitening agents, dispersants, heat stabilizers, photostabilizers, UV absorbers, antistatic agents, coagulants, lubricants, solvents, and the like.

The adhesive composition may have a viscosity at 25° C. of about 300 cP to about 50,000 cP. Within this viscosity range, the adhesive composition can have good coatability and thickness uniformity.

The adhesive composition may be prepared through partial polymerization of the monomer mixture for the (meth)acrylic copolymer having a hydroxyl group with the initiator, followed by adding at least one of an additional macro-monomer and the organic nanoparticles. The initiator, the crosslinking agent, the silane coupling agent, and the additives described above may be further added to the adhesive composition. Alternatively, the adhesive composition may be prepared by partially polymerizing a mixture including the monomer mixture for the (meth)acrylic copolymer having a hydroxyl group and at least one of the macro-monomer and the organic nanoparticles, followed by adding at least one of the additional initiator, the macro-monomer and the organic nanoparticles. The crosslinking agent and the additives described above may be further added to the mixture. The crosslinking agent, the silane coupling agent, and the additives described above may be further added to the adhesive composition. Partial polymerization may include solution polymerization, suspension polymerization, photopolymerization, bulk polymerization, or emulsion polymerization. In an embodiment, solution polymerization may be performed at about 50° C. to about 100° C. by adding an initiator to the monomer mixture. The initiator may include a photopolymerization initiator, such as an acetophenone compound including 2,2-dimethoxy-2-phenylacetophenone, 1-hydroxycyclohexylphenylketone, and the like, without being limited thereto. Partial polymerization may be performed to achieve a viscosity at 25° C. of about 1,000 cP to 10,000 cP, and, in an embodiment, about 4,000 cP to about 9,000 cP. The adhesive film may be produced by a typical method. For example, the adhesive film may be produced by coating the adhesive composition onto a release film, followed by curing. Curing may be performed under a low-pressure lamp at a wavelength of about 300 nm to about 400 nm and a dose of about 400 mJ/cm² to about 3,000 mJ/cm² in an oxygen-free state.

An optical member according to an embodiment of the present invention includes an optical film, and an adhesive film formed on at least one surface of the optical film, wherein the adhesive film includes the adhesive film according to an embodiment of the present invention. Accordingly, the optical member exhibits good bending properties and/or good foldability, and thus can be used in a flexible display.

In an embodiment, the optical film provides optical functions, for example, polarization, optical compensation, display quality improvement and/or conductivity, to a display. Examples of the optical film may include a window film, a window, a polarizing plate, a color filter, a retardation film, an elliptical polarizing film, a reflective film, an anti-reflection film, a compensation film, a brightness improving film, an alignment film, a light diffusion film, a glass shatterproof film, a surface protective film, an OLED device barrier layer, a plastic LCD substrate, and a transparent electrode film including indium tin oxide (ITO), fluorinated tin oxide (FTO), aluminum-doped zinc oxide (AZO), carbon nanotubes (CNT), Ag nanowires, graphene, or the like. These optical films may be easily manufactured by those of ordinary skill in the art.

For example, a touch pad may be attached to a window film or an optical film via the adhesive film, thereby forming a touch panel. Alternatively, the adhesive film may be applied to a typical polarizing film as in the related art.

In another embodiment, the optical film is an optically transparent film, and an optical member including the optical film and the adhesive film may act as a support layer of a display element. For example, the display element may include a window film and the like. The window film may include the optical member and a window coating layer (for example, a silicon coating layer) formed on the optical member. In an embodiment, the optical film may have a total luminous transmittance of 90% or more in the visible range, and may be formed of at least one resin selected from among cellulose resins such as triacetylcellulose, polyester resins such as polyethylene terephthalate, polyethylene naphthalate, polybutylene terephthalate and polybutylene naphthalate, polycarbonate resins, polyimide resins, polystyrene resins, poly(meth)acrylate resins such as poly(methyl methacrylate), cyclic olefin polymer resins, acrylic resins, and polyamide resins. The optical film may have a thickness of 10 μm to 100 μm, and, in an embodiment, 20 μm to 75 μm, and, in an embodiment, 30 μm to 50 μm. Within this thickness range, the optical member can be used as the support layer in the display element.

The optical member may be a two-layer film laminate that includes an optical film and an adhesive film formed on a surface of the optical film. Alternatively, the optical member may be a three- or more layer film laminate that includes at least two optical films attached to each other via the adhesive film according to the present invention.

In an embodiment, the optical member may be a three-layer film laminate that includes a first optical film, a second optical film, and an adhesive film interposed between the first optical film and the second optical film to attach the first optical film to the second optical film, wherein the adhesive film is an adhesive film according to an embodiment of the present invention. Each of the first optical film and the second optical film may be formed of at least one resin selected from among a polyester resin including a polyethylene terephthalate resin, a polycarbonate resin, a polyimide resin, a poly(meth)acrylate resin, a cyclic olefin polymer resin, and an acrylic resin. Each of the first optical film and the second optical film may have a thickness of 10 μm to 100 μm, and, in an embodiment, 20 μm to 75 μm, and, in an embodiment, 30 μm to 50 μm, and the adhesive film may have a thickness of 10 μm to 100 μm. Within this thickness range, the optical member can maximize or increase impact resistance while maintaining good foldability. The first optical film and the second optical film may have different thicknesses and may be formed of different materials.

An optical display according to an embodiment of the present invention includes the adhesive film according to the present invention. The optical display may include any of an organic light emitting display, a liquid crystal display, and the like. The optical display may include a flexible display. In some embodiments, the optical display may include a non-flexible display.

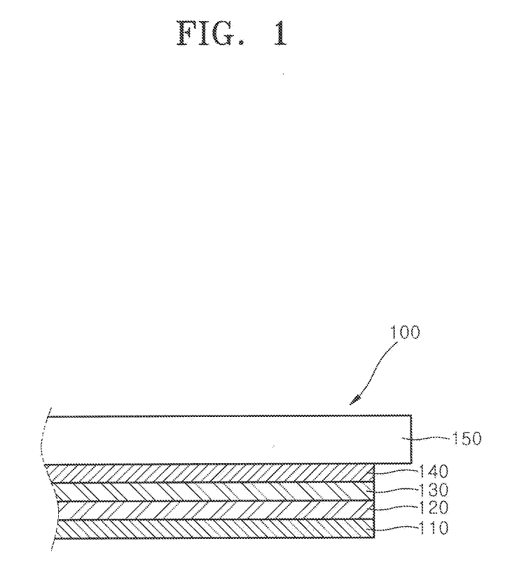

Next, a flexible display according to an embodiment of the present invention will be described with reference to FIG. 1. FIG. 1 is a sectional view of a flexible display according to an embodiment of the present invention.

Referring to FIG. 1, a flexible display 100 according to an embodiment of the present invention includes a display part 110, an adhesive layer 120, a polarizing plate 130, a touchscreen panel 140, and a flexible window film 150, wherein the adhesive layer 120 may include the adhesive film according to an embodiment of the present invention.

The display part 110 serves to drive the flexible display 100, and may include a substrate and an optical device including an OLED, an LED, a QLED (quantum dot light emitting diode), or an LCD element formed on the substrate. Although not shown in FIG. 1, the display part 110 may include a lower substrate, a thin film transistor, an organic light emitting diode, a flattening layer, a protective layer, and an insulating layer.

The polarizing plate 130 can realize polarization of internal light or prevent or substantially prevent reflection of external light to realize a display, or can increase contrast of the display. The polarizing plate 130 may be composed of a polarizer alone. Alternatively, the polarizing plate 130 may include a polarizer and a protective film formed on one or both surfaces of the polarizer. Alternatively, the polarizing plate 130 may include a polarizer and a protective coating layer formed on one or both surfaces of the polarizer. As the polarizer, the protective film and the protective coating layer, a typical polarizer, a typical protective film and a typical protective coating layer known in the art may be used.

The touchscreen panel 140 generates electrical signals through detection of variation in capacitance when a human body or a conductor, such as a stylus, touches the touchscreen panel 140, and the display part 110 may be driven by such electrical signals. The touchscreen panel 140 is formed by patterning a flexible conductor, and may include first sensor electrodes and second sensor electrodes each formed between the first sensor electrodes and intersecting the first sensor electrodes. The touchscreen panel 140 may include a conductive material, such as metal nanowires, conductive polymers, and carbon nanotubes, without being limited thereto.

In an embodiment, the touchscreen panel 140 may be stacked on the polarizing plate 130 via an adhesive film or a bonding film, or, alternatively, the touchscreen panel 140 may be integrally formed with the polarizing plate 130 by incorporating the polarizer or the polarizing plate therein.

The flexible window film 150 is formed as the outermost layer of the flexible display 100 to protect the flexible display 100.

Although not shown in FIG. 1, the adhesive films according to one or more embodiments of the present invention may be further formed between the polarizing plate 130 and the touchscreen panel 140 and/or between the touchscreen panel 140 and the flexible window film 150 to reinforce bonding between the polarizing plate 130, the touchscreen panel 140, and the flexible window film 150.

Next, the present invention will be described in further detail with reference to some examples. However, it should be understood that these examples are provided for illustration only and are not to be construed in any way as limiting the present invention.

### Preparative Example

Organic nanoparticles were prepared by emulsion polymerization. The core was formed of poly(butyl acrylate), and the shell was formed of poly(methyl methacrylate). In the organic nanoparticles, the shell was present in an amount of 35 wt %, and the core was present in an amount of 65 wt %. The organic nanoparticles had an average particle diameter of 100 nm and a refractive index of 1.46.

### EXAMPLE 1

100 parts by weight of a monomer mixture of the hydroxyl group-containing (meth)acrylate and the alkyl group-containing (meth)acrylate as listed in Table 1, 5 parts by weight of the organic nanoparticles prepared in the Preparative Example, and 0.005 parts by weight of Irgacure 651 as an initiator were sufficiently mixed in a reactor. After replacing dissolved oxygen in the reactor with nitrogen gas, the mixture was subjected to partial polymerization through irradiation with UV light for several minutes using a low-pressure mercury lamp, thereby preparing a viscous liquid having a viscosity of 5,000 cP at 25° C. 0.3 parts by weight of an initiator (Irgacure184), 0.01 parts by weight of hexanediol diacrylate as a crosslinking agent, and 0.1 parts by weight of 3-glycidoxypropyltrimethoxysialne (KBM-403) as a silane coupling agent were added to the viscous liquid and mixed therewith, thereby preparing an adhesive composition. The adhesive composition was coated onto a polyethylene terephthalate (PET) release film and irradiated with UV light at a dose of 2,000 mJ/cm², thereby preparing an adhesive sheet in which an adhesive film is stacked on the PET film.

### EXAMPLE 2 to EXAMPLE 5

Each adhesive sheet of an adhesive film and a PET film was fabricated In the same manner as in Example 1, except that the components of the adhesive composition were changed as listed in Table 1.

### Comparative Example 1

An adhesive sheet of an adhesive film and a PET film was fabricated in the same manner as in Example 1, except that the components of the adhesive composition were changed as listed in Table 1.

The adhesive films of Examples and Comparative Examples were evaluated as to the properties as listed in Table 1, and evaluation results are shown in Table 1

(1) Modulus: Viscoelasticity was measured at a shear rate of 1 rad/sec and a strain of 1% under auto-strain conditions using a rheometer (MCR-501, Anton Paar Co., Ltd.). After removal of release films from adhesive sheets, 50 μm thickness adhesive films were stacked to a thickness of 500 μm, followed by punching the stack using an 8 mm diameter punching machine, thereby preparing a specimen. With a load of 300 gf applied to the specimen using an 8 mm jig: measurement of modulus was performed at −20° C., 25° C., and 80° C. while increasing temperature from −60° C. to 90° C. at a rate of 5° C./min.

(2) Glass transition temperature of adhesive film: After removal of release films from the adhesive sheets, the glass transition temperature of a 50 μm thickness adhesive film was measured using a DSC Q20 (TA Instruments). After removal of the release film from adhesive sheet, 0.005 g of an adhesive film was placed and sealed on a pan, Then, the adhesive film was heated to about 100° C. at a heating rate of about 10° C./min, maintained in an equilibrium state for about 5 minutes, cooled to about −120° C. at a rate of about 10° C./min, and maintained at about —120° C. for about 10 minutes. Then, the adhesive film was heated from about −120° C. to about 160° C. at a rate of about 10° C./min in order to obtain an endothermic transition curve. An inflection point of the endothermic transition curve was determined as the glass transition temperature.

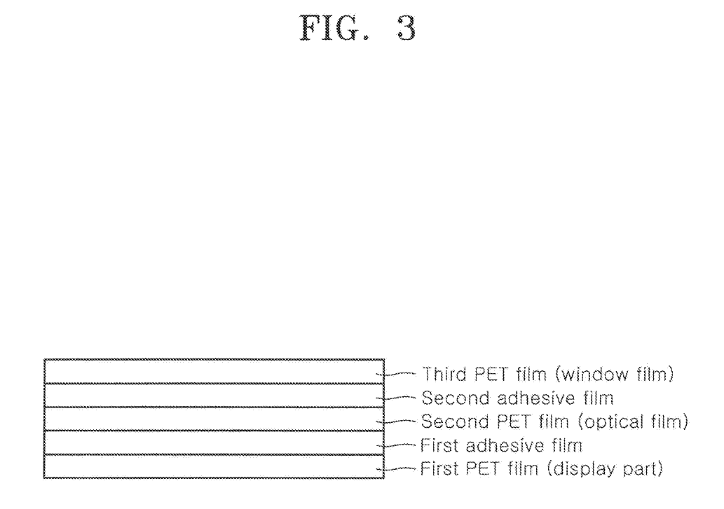

(3) Foldability Evaluation: A sample simulating a display having a five-layer structure, in which a display part, a first adhesive film, an optical film, a second adhesive film, and a window film, as described below, were sequentially stacked one above another as shown in FIG. 3, was prepared using the adhesive films of the Examples and Comparative Example.
Display part: First PET film (thickness: 100 μm, Cosmoshine TA015, Toyobo Inc.)
First adhesive film: Adhesive film (thickness: 50 μm) prepared in the Examples and Comparative Example
Optical film (e.g., polarizing plate, touchscreen panel): Second PET film (thickness: 50 μm)
Second adhesive film: Adhesive film (thickness: 50 μm) prepared in the Examples and Comparative Example
Window film: Third PET film (thickness: 125 μm)

The sample was cut into a specimen having a size of length×width (100 cm×160 cm), which in turn was autoclaved at 50° C. under a pressure of 3.6 bar for 1,000 sec. The specimen was secured to a folding test instrument (CFT series, COVOTEC Co., Ltd.) by bending the specimen towards the window film such that the width of the specimen was halved. A cycle of bending the specimen was repeated until delamination or bubble generation occurred In the specimen under conditions of at least one of −20° C., or 60° C. and 93% RH, at a bending rate of 30 cycles per minute such that the specimen was repeatedly bent and unbent at 0° C. and 180° C. in a direction of width of the specimen, and a bent portion of the specimen had a radius of curvature of 3 mm. One cycle refers to an operation of bending the adhesive film in half once and unfolding the adhesive film back to an original state. No bubble generation means a bubble generation area ratio of 0%, and, as the bubble generation area, a ratio of the total area occupied by bubbles to the area of the adhesive film was calculated by analyzing an image obtained through an optical microscope (EX-51, Olympus Co. Ltd.) with Mac-view software (Mountech Co., Ltd.).

(4) Restoration force: An adhesive film was obtained by releasing a PET release film from each of the adhesive sheets of the Examples and Comparative Example. Restoration force was measured at 25° C. using a TA.XT_Plus Texture Analyzer (Stable Micro System Co., Ltd.).

As shown in FIGS. 4A and 4B, a specimen was prepared by attaching two PET films (length×width×thickness: 50 mm×20 mm×75 μm) to each other via an adhesive film having a size of length×width (20 mm×20 mm) such that two ends of the two PET films were attached to each other in order of the first PET film/adhesive film/second PET film to have a contact area of 20 mm×20 mm between the PET film and the adhesive film. Jigs were secured to both ends of the PET films of the specimen. Here, a contact area between each of the first and second PET films and the jig was adjusted to length×width (15 mm×20 mm). With one of the jigs secured under a load of 10 MPa, the other jig was pulled at 300 mm/min until the adhesive film had a length X₂ (unit: μm) of 1,000% of an initial thickness X₀ (unit: μm) thereof, that is, 10 times the initial thickness X₀ of the adhesive film, and was maintained for 10 seconds, followed by restoring the other jig at the same speed (i.e. at 300 mm/min) as the pulling speed. A stretched length of the adhesive film upon application of 0 kPa to the adhesive film after the adhesive film was stretched to a length of 1,000% of an initial thickness thereof was defined as X₁. Referring to the graph of FIG. 5, the X-axis is the stretched length of the adhesive film, and the Y-axis is force applied to the adhesive film. Restoration force was calculated by Equation 1.

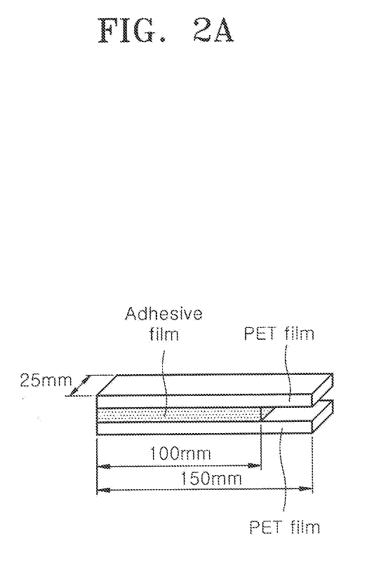

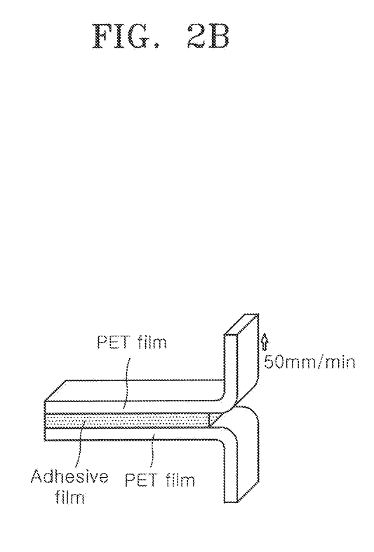

(5) Peel strength: A PET film having a size of 150 mm×25 mm×75 μm (length×width×thickness) was subjected to corona treatment twice (total dose: 156) under plasma discharge at 78 doses using a corona treatment device. The corona- treated surfaces of the PET films were stacked on both surfaces of an adhesive film having a size of 100 mm×25 mm×50 μm (length×width×thickness), thereby preparing a specimen, as shown in FIG. 2A. The specimen was autoclaved under conditions of about 3.5 bar and about 50° C. for about 1,000 seconds and secured to a TA.XT_Plus texture analyzer (Stable Micro System Co., Ltd.). Referring to FIG. 2B, with each of the PET films secured at one side thereof to the TA.XT_Plus Texture Analyzer at 25° C., T-peel strength was measured by pulling the other side of each of the PET films at 50 mm/min.

TABLE 1

| | | | | | | | Comparative |
|---|---|---|---|---|---|---|---|
| | | Example 1 | Example 2 | Example 3 | Example 4 | Example 5 | Example 1 |
| n-BA | | 5 | 10 | 0 | 0 | 0 | 0 |
| (parts by weight) | | | | | | | |
| 2-EHA | | 75 | 75 | 80 | 75 | 80 | 65 |
| (parts by weight) | | | | | | | |
| 4-HBA | | 15 | 10 | 20 | 25 | 20 | 0 |
| (parts by weight) | | | | | | | |
| 3-HPA | | 5 | 5 | 0 | 0 | 0 | 0 |
| (parts by weight) | | | | | | | |
| 2-HEA | | 0 | 0 | 0 | 0 | 0 | 35 |
| (parts by weight) | | | | | | | |
| Organic nanoparticles | | 5 | 3 | 3 | 3 | 0 | 0 |
| (parts by weight) | | | | | | | |
| Macro-monomer | | 0 | 0 | 0 | 0 | 5 | 0 |
| (parts by weight) | | | | | | | |
| Irgacure 651 | | 0.005 | 0.005 | 0.005 | 0.005 | 0.005 | 0.005 |
| (parts by weight) | | | | | | | |
| Irgacure 184 | | 0.3 | 0.3 | 0.3 | 0.3 | 0.3 | 0.3 |
| (parts by weight) | | | | | | | |
| Crosslinking agent | | 0.01 | 0 | 0 | 0 | 0 | 0 |
| (parts by weight) | | | | | | | |
| Silane coupling agent | | 0.1 | 0.1 | 0 | 0 | 0.1 | 0 |
| (parts by weight) | | | | | | | |
| Modulus (kPa) | @−20° C. | 140 | 105 | 74 | 87.7 | 97 | 695 |
| | @25° C. | 42 | 27 | 29 | 38.1 | 34 | 38 |
| | @80° C. | 30 | 18 | 25 | 27.3 | 18 | 29 |

| | | | | | | |
|---|---|---|---|---|---|---|
| Modulus@80° | 1:4.67 | 1:5.83 | 1:2.96 | 1:3.21 | 1:5.39 | 1:23.97 |
| C.:Modulus@−20° C. | | | | | | |
| Glass transition | −56.1 | −57.2 | −48.4 | −47.6 | −53.2 | −30.9 |
| temperature (° C.) | | | | | | |
| Foldability evaluation | 200,000 | 200,000 | 200,000 | 60,000 | 150,000 | 10,000 |
| (@−20° C., cycles) | cycles | cycles | cycles | cycles | cycles | cycles |
| Foldablity evaluation | 110,000 | 130,000 | 100,000 | 50,000 | 120,000 | 1000 |
| (@60° C. and 93% | cycles | cycles | cycles | cycles | cycles | cycles |
| RH, cycles) | | | | | | |
| Restoration force | 92 | 86 | 85 | 88 | 90 | 89 |
| (@25° C., %) | | | | | | |
| Peel strength | 1428 | 1324 | 1136 | 1468 | 1333 | 1700 |
| (@25° C., gf/in) | | | | | | |

*n-BA: n-butyl acrylate, 2-EHA: 2-ethylhexyl acrylate (LG Chemicals), 4-HBA: 4-hydroxybutyl acrylate (Osaka Organic Chemical Industry), 3-HPA: 3-hydroxybutyl acrylate, 2-HEA: 2-hydroxyethyl acrylate (Nippon Shokubai), macro-monomer: AA-6 (Toakosei), crosslinking agent: 1,6-hexanediol diacrylate, silane coupling agent: 3-glycidoxypropyltrimethoxysilane

As shown in Table 1, the adhesive films of the Examples exhibited good foldability at low temperature, particularly, under low temperature and/or high temperature/humidity conditions even when stacked together with a plurality of display elements or optical films. In addition, the adhesive films of the Examples had a small difference in modulus between low temperature and high temperature to provide good reliability. Further, the adhesive film of the Examples had high peel strength. Accordingly, an adhesive film according to one or more embodiments of the present invention exhibits good foldability not only at room temperature, but also under low temperature and/or high temperature/humidity conditions. Further, an adhesive film according to one or more embodiments of the present invention exhibits good foldability under low temperature and/or high temperature/humidity conditions not only when used alone, but also when stacked together with a plurality of display devices or optical films. Further, an adhesive film according to one or more embodiments of the present Invention has a small difference in modulus between low temperature and high temperature to provide good reliability. Further, an adhesive film according to one or more embodiments of the present invention has high peel strength when used together with display elements and/or optical films. According to an aspect of one or more embodiments of the present invention, an optically transparent adhesive film is provided that can be used in an optical display.

It is to be understood that various modifications, changes, alterations, and equivalent embodiments can be made by those skilled in the art without departing from the spirit and scope of the invention.

What is claimed is:

1. An adhesive film comprising a (meth)acrylic copolymer including a hydroxyl group and formed of a monomer mixture comprising a hydroxyl group-containing (meth)acrylate and an alkyl group-containing (meth)acrylate,
the adhesive film having a glass transition temperature of about −35° C. or less. and
the adhesive film allowing about 50,000 cycles or more of bending before delamination between the adhesive film and a PET film, cracking, or bubble generation occurs in a specimen having a length of 100 cm and a width of 160 cm and prepared by sequentially stacking a first PET film having a thickness of 100 μm, the adhesive film having a thickness of 50 μm, a second PET film having a thickness of 50 μm, the adhesive film having a thickness of 50 μm, and a third PET film having a thickness of 125 μm to have a five-layer structure, as measured by securing the specimen to a folding test instrument by bending the specimen towards the third PET film such that the width of the specimen is halved, and repeating a cycle of bending the specimen under conditions of at least one of i) −20° C., and ii) 60° C. and 93% relative humidity, at a bending rate of 30 cycles per minute, such that the specimen is repeatedly bent and unbent at 0° and 180° in a direction of the width of the specimen, and a bent portion of the specimen has a radius of curvature of 3 mm, and one cycle refers to an operation of bending the specimen in half once and unfolding the specimen back to an original state.

2. The adhesive film according to claim 1, wherein the glass transition temperature of the adhesive film is about −60° C. to about −35° C..

3. The adhesive film according to claim 1, wherein the adhesive film has a restoration force at 25° C. of about 60% or more, as represented by the following Equation 1:
Restoration force=(1−X₁)/(X₂))×100,
where X₁ and X₂ are values obtained under the following procedure, where both ends of a polyethylene terephthalate (PET) film are defined as a first end and a second end, respectively, and a specimen for calculation of restoration force is prepared by attaching a first PET film and a second PET film to each other via an adhesive film having a size of 20 mm×20 mm, such that two ends of the first PET film and the second PET film are attached to each other in order of a first end of first PET film, the adhesive film, and a second end of second PET film, wherein, thereafter, one jig is secured to a second end of the first PET film and another jig is secured to a first end of the second PET film, one of the jigs is secured under a load of 10 MPa, and the other of the jigs is pulled at 25° C. and at about 300 mm/min until the adhesive film has a length X₂ of 1,000% of an initial thickness X₀ of the adhesive film, and is maintained for about 10 seconds, followed by restoring the other of the jigs at about 300 mm/min to obtain a stretched length X₁ of the adhesive film upon application of 0 kPa to the adhesive film in a graph, wherein an X-axis of the graph is the stretched length of the adhesive film, and a Y-axis of the graph is a force applied to the adhesive film.

4. The adhesive film according to claim 1, wherein the adhesive film has a ratio of modulus at 80° C. to modulus at −20° C. of about 1:1 to about 1:10.

5. The adhesive film according to claim 1, wherein the adhesive film has a modulus at −20° C. of about 10 kPa to about 500 kPa.

6. The adhesive film according to claim 1, wherein the hydroxyl group-containing (meth)acrylate is present in an amount of about 10 wt % to about 30 wt % in the monomer mixture.

7. The adhesive film according to claim 1, wherein the hydroxyl group-containing (meth)acrylate comprises a (meth)acrylate containing a C₂ to C₄ alkyl group having at least one hydroxyl group.

8. The adhesive film according to claim 1, wherein the adhesive film is formed of an adhesive composition comprising the monomer mixture comprising the hydroxyl group-containing (meth)acrylate and the alkyl group-containing (meth)acrylate or the (meth)acrylic copolymer having a hydroxyl group prepared by partial polymerization thereof; at least one of a macro-monomer and organic nanoparticles; and an initiator.

9. The adhesive film according to claim 8, wherein the organic nanoparticles have an average particle diameter of about 10 nm to about 400 nm.

10. The adhesive film according to claim 8, wherein the organic nanoparticles have a core-shell structure, the core and the shell satisfying the following Equation 2:
Tg(c)<Tg(s),
where Tg(c) is a glass transition temperature of the core, and Tg(s) is a glass transition temperature of the shell.

11. The adhesive film according to claim 8, wherein the organic nanoparticles are present in an amount of about 0.1 parts by weight to about 20 parts by weight relative to 100 parts by weight of the monomer mixture.

12. The adhesive film according to claim 8, wherein the macro-monomer is present in an amount of about 0.1 parts by weight to about 20 parts by weight relative to 100 parts by weight of the monomer mixture.

13. The adhesive film according to claim 1, further comprising:
at least one of a crosslinking agent and a silane coupling agent.

14. The adhesive film according to claim 1, wherein the adhesive film has a haze of about 2% or less at a wavelength of 380 nm to 780 nm.

15. An optical member comprising an optical film and an adhesive film formed on at least one surface of the optical film,
wherein the adhesive film comprises the adhesive film according to claim 1.

16. The optical member according to claim 15, wherein the optical member is a three-layer film laminate comprising a first optical film, a second optical film, and the adhesive film between the first optical film and the second optical film to attach the first optical film to the second optical film.

17. The optical member according to claim 16, wherein each of the first optical film and the second optical film is formed of at least one resin selected from among a polyester resin, a polycarbonate resin, a polyimide resin, a poly(meth)acrylate resin, a cyclic olefin polymer resin, and an acrylic resin.

18. The optical member according to claim 16, wherein each of the first optical film and the second optical film has a thickness of about 10 μm to about 100 μm, and the adhesive film has a thickness of about 10 μm to about 100 μm.

19. An optical display comprising the adhesive film according to claim 1.

20. A window film comprising:
the optical member according to claim 15; and
a window coating layer on the optical member.
